(19) United States
(12) Patent Application Publication
(10) Pub. No.: US 2012/0190608 A1
(43) Pub. Date: Jul. 26, 2012

(54) COATED CRYSTALLINE POLYCARBOXYLATE PARTICLES

(75) Inventors: Kai Heppert, Ludwigshafen (DE); Judith Preuschen, Ludwigshafen (DE); Ralf Wiedemann, Mira (IT)

(73) Assignee: RECKITT BENCKISER N.V., Hoofddorp (NL)

(21) Appl. No.: 13/321,226

(22) PCT Filed: May 18, 2010
(86) PCT No.: PCT/GB10/00989

§ 371 Date: Mar. 2, 2012

(30) Foreign Application Priority Data
May 20, 2009 (GB) 0908641.4

(51) Int. Cl. C11D 17/00; C11D 3/60

(52) U.S. Cl. 510/446; 510/533; 510/477

(57) ABSTRACT

A particulate material comprising a crystalline polycarboxylate wherein the particles of the material have a coating. A solid detergent composition comprising a crystalline polycarboxylate containing particulate material of the invention is also provided. The particulate material of the invention exhibits good building/chelancy properties and is especially suitable for use in detergent tablets.

The invention concerns a particle comprising a crystalline polycarboxylate builder and a coating.

Household detergents are used widely in many applications including laundry care and for hard-surface cleaning such as in an automatic dishwasher. The detergents are commonly available in many product formats including liquids, powders, gels and solids.

It is recognised that a common household detergent is usually made up of a number of different components. One component that is typically present in a laundry/automatic dishwasher detergent is a builder.

The builder is used as a chelating agent to aid the removal/capture of metal ions in solution. With their use deposits of metal ion based sediments (such as limescale) within automatic washing machines are reduced and the cleaning process is enhanced (certain stains incorporate a metal ion component, e.g. such as tea stains which comprise a calcium/tannin complex).

In the past and up until recently builders based upon phosphate have been used. These have the advantage of being inexpensive, compatible with other detergent components (both in solid and liquid detergent formulations) and washing machines, and widely available. However, one problem with the use of phosphate based builders is that of environmental pollution: excess phosphates in water courses are connected with detrimental environmental effects such as eutrification and excess algal growth, leading to other issues such as a reduction in fish populations.

Consequently the use of phosphates has been legislated against in certain jurisdictions and is being legislated against in further jurisdictions.

Thus there is a need for alternative builders/chelating agents.

One possible alternative is to use a salt of a polyfunctional carboxylic acid such as citrate. However, whilst salts such as citrate are more environmentally acceptable, these types of builders are only commercially available in crystalline form. The use of crystals can be problematic, particularly when producing tabletted detergent compositions in a compression process as the crystal comprising compositions are difficult to compress. Indeed, in order to form a crystal containing tablet typically higher compression forces are needed. This is disadvantageous in that not only is more robust compression equipment required (with consequentially higher energy uses) but also the dissolution proprieties of the tablet are adversely affected.

It is an object of the present invention to obviate/mitigate the problems outlined above.

According to a first aspect of the present invention there is provided a particulate material comprising a crystalline polycarboxylate wherein the particles of the material have a coating.

According to a second aspect of the present invention there is provided a solid detergent composition comprising a crystalline polycarboxylate containing particulate material according to the first aspect of the invention.

The coating may completely or substantially surround the particulate or it may partially surround it. It is especially preferred according to the present invention that the coating substantially or completely surrounds the particulate.

Generally the coating comprises, or is, a film forming material. Preferably the film forming material has a melting point over 40° C. and more preferably over 50° C.

The coating is preferably non-elastic. In the context of the present invention this means that a 6 mm thick layer of coating is irreversibly penetrated to a depth of at least 0.2 mm when a steel ball (diameter 2.3 mm) is pressed thereon for 20 seconds with a load of 2 kg. Preferably the penetration depth is at least 0.3 mm.

Preferred coating materials comprise one or more of oligomers/(co)polymers such as polysaccharides (dextrins, inulins), polyacrylates, polyvinyl alcohol, polyvinyl pyrrolidone, (poly)alkylene glycols and derivatives and mixtures thereof. The coating may be modified with a plasticiser and/or a filler.

Preferably the coating is a (poly)alkylene glycol or a derivative thereof.

With the use of the coating of the invention, e.g. a (poly)alkylene glycol coating, the compression/dissolution problems associated with crystalline polycarboxylates have been found to be addressed. Thus the crystalline polycarboxylates can be incorporated into a tabletted detergent formulation for use as a builder without causing any problems of stability/integrity. Detergent products made using these particles have been found to exhibit excellent storage stability and dissolution.

As most (poly)alkylene glycols are neutral molecules the coating of the crystalline polycarboxylates particles with these glycols does not limit their use in any particular detergent application, the coated crystalline polycarboxylates can still be used in automatic dishwasher detergent formulations.

The use of a (poly)alkylene glycol as a coating has also been found to be advantageous when the particles of the invention are used in an injection moulding process for the preparation of a detergent body: in this application the (poly)alkylene glycol is an excellent processing aid.

Preferably the weight ratio of the crystalline polycarboxylate to the coating e.g. (poly)alkylene glycol is in the range of from 5:1 (i.e. 84 wt % crystalline polycarboxylate and 16 wt % glycol) to 30:1 (i.e. 97 wt % crystalline polycarboxylate and 3 wt % glycol), preferably in the range of from 10:1 to 25:1. The particles may further incorporate auxiliary materials, usual detergent additives or fillers.

Preferably the (poly)alkylene glycol comprises polyethylene glycol, polypropylene glycol or a derivative thereof (such as alkylated fatty alcohols and/or fatty acids) and mixtures thereof.

Most preferably the glycol is polyethylene glycol having a molecular weight in the range of from 1500 to 20000.

Generally the crystalline polycarboxylate has an initial particle size (before coating) in the range of from 40-1200 μm, more preferably 50-1000 μm.

Generally the crystalline polycarboxylate has a particle size (after coating) such that at least 90% by weight of the particles have a particle size in the range of from 80-1300 μm. After coating the particulate may comprise an agglomerate of individual particles, with the agglomerate preferably being of the aforementioned particle size.

Most preferably the crystalline polycarboxylate comprises citric acid or a metal salt of citric acid (e.g. sodium citrate).

The particulate is preferably formed in a process comprising a fluid bed in which the crystals are fluidised and coating by the application of a spray of coating material.

The particulate is preferably for use in an automatic washing detergent formulation e.g. such as a dishwasher detergent/additive or a laundry detergent/additive.

The detergent composition may comprise a powder, a compressed particulate body or an injection moulded body. Most preferably the detergent composition is in tabletted form. The detergent composition may be packaged in a water soluble material such as a water soluble film.

Generally the particulate is incorporated into the detergent/additive at a level of more than 10 wt %, more preferably around 20 wt %.

The composition may further incorporate auxiliary materials, such as the usual detergent additives or fillers, e.g. one or more of the following agents; bleach, corrosion inhibition agent, fragrance, co-builder, surfactant, binding agent, dye, acidity modifying agent, dispersion aid, or enzyme.

The invention is now further described with reference to the following non-limiting Examples. Further examples within the scope of the invention will be apparent to the person skilled in the art.

### EXAMPLE 1

### Hardness Trial

The surface hardness of a 20 g tablet of dimensions 37 mm (width)×27 mm (depth)×15 mm (height) was determined by examining the penetration depth of a test prod into the sample surface. A spherical test prod was put on the surface of the sample. After a defined time (20 seconds) the penetration depth was read off from the dial gauge. The penetration depth was indicated in mm. In the test a steel cone was used, weighing 2 kg.

The test results are summarized in the following paragraph:

### Coating Material #1: Polyethylene Glycol 6000

(prepared by melting the PEG at 70° C. and allowing it to solidify at room temperature)
Penetration depth: 0.53+/−0.07 mm

### Coating Material #2: Acusol 588 (Comparative)

(prepared by drying an aqueous solution of the Acusol at 80° C. over several days)
Penetration depth: 0.08+/−0.02 mm.

### EXAMPLE 2

### Plant Trial

The trials were carried out on a Glatt Type GPCG3.1 fluidized bed spray drying.

### Principle of Operation:

With top spray coating in a batch fluid bed process, particles were fluidized in a flow of heated air, which was introduced into the product container via a base plate. The coating liquid was sprayed into the fluid bed from above against the air flow (countercurrent) by means of a nozzle. Drying took place as the particles continued to move upwards in the air flow. Small droplets and a low viscosity of the spray medium ensured that the distribution was uniform.

The following trisodium citrates (TSC) were used in the tests:

| Sieve Size | | |
|---|---|---|
| (μm) | TSC A | TSC B |
| 0-50 | 0.3 | 0 |
| 50-100 | 0.9 | 2.9 |
| 100-125 | 0.8 | 5.2 |
| 125-150 | 1.5 | 8.3 |
| 150-175 | 2.2 | 10.3 |
| 175-200 | 3.2 | 13.7 |
| 200-225 | 4.1 | 15.3 |
| 225-250 | 5.6 | 16.6 |
| 250-275 | 6.1 | 12.2 |
| 275-300 | 7.1 | 7.9 |
| 300-325 | 8.2 | 3.3 |
| 325-350 | 9.3 | 1.1 |
| 350-375 | 8.9 | 0.4 |
| 375-400 | 8.5 | 0.2 |
| 400-450 | 13.1 | 0.2 |
| 450-500 | 9.1 | 0.1 |
| 500-550 | 5.8 | 0 |
| 550-600 | 3.1 | 0 |
| 600-625 | 0.9 | 0 |
| 625-675 | 1.0 | 0 |
| 675-750 | 0.4 | 0 |
| 750-825 | 0.1 | 0 |
| 825-900 | 0 | 0 |
| 900-1000 | 0 | 0 |

TSC C was as TSC A but TSC C was milled such that all of particles had a particle size of less than 200 μm. Agglomeration of these particles occurred after coating.

Coating with PEG (6000 or 3350)

The PEG spray solution is melted at ˜60° C. and kept on a hotplate.

The molten PEG is sprayed on a fluidised bed of TNC such that 3-10 wt % of PEG is coated onto the particles.

The fluidised bed was operated under the following parameters:—

Inlet air volume: 200-300 m³/hour
Inlet air temperature: 100-120° C.
Product temperature: 40-50° C.
Spray pressure: 2.5-3 bar
Spray air temperature: room temperature

For TSC C the milled particles were allowed to agglomerate in the spray process.

Coating with Polyacrylates (Acusol 588 or 445 from Rohm and Haas)

The polyacrylate spray solution (20% aqueous solution) is sprayed on a fluidised bed of TNC such that 3-10 wt % of polyacrylate is coated onto the particles.

The fluidised bed was operated under the following parameters:—

Inlet air volume: 200-300 m³/hour
Inlet air temperature: 120° C.
Product temperature: 50-60° C.
Spray pressure: 2.5-3 bar
Spray air temperature: room temperature

### EXAMPLE 3

### Compressibility (C20) Analysis

The following formulation was been used to measure the C20 value of the coated products.

| Raw materials | % (w/w |
|---|---|
| Sodium percarbonate coated | 19.50 |
| Trisodium Citrate (as below) | 55.00 |
| Sodium bicarbonate for tablets | 16.35 |
| PEG 1500 | 3.50 |
| PEG 6000 | 2.00 |
| HEDP 4 NA (88.5% wt) | 0.30 |
| Lutensol AT 25 | 3.00 |
| BTA | 0.35 |

### Definition of the C20 Index

$$Index C 20 = \frac{Hardness}{Pressure \times Weight} \times 20$$

The C20 index gives a hardness value obtained by applying 1 KN on 20 g of composition when filled in a die (tablet surface 36×26 mm). The value was determined using a ERWEKA Hardness tester. The pressure was read directly from the single punch press. The average pressure from upper and lower punch was calculated. The higher the C20 value the better the compressibility of a powder.

20 g tablets with 200N hardness on Excenter press Kilian SP 300 were made to determine C 20 indices.

C20 Results—Particles in Accordance with the Invention

| Particle | Coating | C20 Value |
|---|---|---|
| TSC A | 10% PEG 6000 | 36.96 |
| TSC A | 6% PEG 6000 | 33.01 |
| TSC A | 6% PEG 3550 | 29.93 |
| TSC A | 6% PEG 1500 | 38.26 |
| TSC C | 10% PEG 6000 | 41.66 |
| TSC C | 6% PEG 6000 | 27.27 |
| TSC C | 6% PEG 3350 | 37.90 |
| TSC B | 10% PEG 6000 | 34.65 |
| TSC B | 6% PEG 6000 | 17.29 |
| TSC B | 6% PEG 3350 | 23.12 |

### C20 Results—Comparative Particles

| Particle | Coating | C20 Value |
|---|---|---|
| TSC A | — | 9.12 |
| TSC A | 10% Acusol 588 G | 11.52 |
| TSC A | 10% Acusol 405 | 11.17 |
| TSC B | 10% Acusol 588 G | 6.48 |
| TSC B | 10% Acusol 405 | 6.83 |

The particles in accordance with the invention show much higher C20 values which indicate better behaviour of the particles in a tablet manufacturing process.

### Storage Performance of Automatic Dishwashing Tablets

Dishwashing tablets containing particles according to the invention (formulation 2) and comparative tablets (formulation 1) were made by pressing the following compositions on a Killian TS 1000 press (tablet surface 36×26 mm). The pressure applied was 70 kN (formulation 2) and 85 kN (formulation 1).

| | Formulation 1 | Formulation 2 |
|---|---|---|
| Component | (wt %) | (wt %) |
| Sodium Citrate (TSC A) | 53.8 | 23.8 |
| Coated Sodium Citrate | — | 30.0 |
| Sodium Percarbonate | 15.0 | 15.0 |
| Sodium Carbonate | 8.0 | 8.0 |
| TAED | 5.0 | 5.0 |
| Sulphonated | 5.0 | 5.0 |
| polycarboxylate (sodium salt) | | |
| PEG 1500 | 4.9 | 4.9 |
| PEG 6000 | 1.2 | 1.2 |
| Fatty alcohol polyglycol ether | 3.1 | 3.1 |
| Protease (Properase) | 1.6 | 1.6 |
| Amylase (Duramyl) | 1.0 | 1.0 |
| Sodium phosphonate | 0.5 | 0.5 |
| BTA | 0.3 | 0.3 |
| Sodium Bicarbonate | 0.2 | 0.2 |
| Glycerol | 0.1 | 0.1 |
| Zinc Sulphate | 0.1 | 0.1 |
| Perfume | 0.1 | 0.1 |
| Total | 100 | 100 |

After storage (6 weeks at 30° C. and 70% humidity, wrapped in a foil having an MVTR of 0.3 g/m²/day) formulation 1 showed some yellowing and poor enzyme stability.

1. A particulate material comprising a crystalline polycarboxylate wherein the particles of the material have a coating.

2. A particulate material according to claim 1, wherein the coating comprises a film forming material.

3. A particulate material according to claim 1, wherein the coating comprises a coating material selected from: polysaccharides, polyacrylates, polyvinyl alcohol, polyvinyl pyrrolidone, (poly)alkylene glycols and derivatives and mixtures thereof.

4. A particulate material according to claim 1, wherein the coating comprises a (poly)alkylene glycol or a derivative thereof.

5. A particulate material according to claim 1, wherein the weight ratio of the crystalline polycarboxylate to the (poly)alkylene glycol is in the range of from 5:1 to 30:1.

6. A particulate material according to claim 1, wherein the (poly)alkylene glycol comprises polyethylene glycol or polypropylene glycol or a derivative thereof and mixtures thereof.

7. A particulate material according to claim 1, wherein the (poly)alkylene glycol comprises polyethylene glycol having a molecular weight in the range of from 1500 to 20000.

8. A particulate material according to claim 1, wherein the crystalline polycarboxylate has an initial particle size (before coating) in the range of from 40-1200 mm.

9. A particulate material according to claim 1, wherein the crystalline polycarboxylate has a particle size (after coating) such that 90 wt % of the particles have a particle size in the range of from 80-1300 mm.

10. A particulate material according to claim 1, wherein the crystalline polycarboxylate comprises citric acid or a metal salt thereof.

11. A solid detergent composition comprising a crystalline polycarboxylate containing particulate material according to claim 1.

12. A solid detergent according to claim 11, wherein the composition is in tabletted form.
